(19) United States
(12) Patent Application Publication
(10) Pub. No.: US 2007/0082136 A1
(43) Pub. Date: Apr. 12, 2007

(54) Buffer brush stain applicator

(76) Inventor: Edward Thomas Biernot, Port Huron, MI (US)

Correspondence Address: EDWARD THOMAS BIERNOT, 3203 OMAR ST., PORT HURON, MI, 48060, US

(21) Appl. No.: 11/246,445

(22) Filed: Oct. 7, 2005

(51) Int. Cl. B05D 3/12; B05C 1/00

(52) U.S. Cl. 427/355; 118/200; 118/201

(57) ABSTRACT

A improved method of applying stain to wood-floors by combining the elements of carpet as the carrier and brush that applies the stain though its shape and texture along with the mechanical assistance of a buffers performance, weight and (178)RPM cannot be consistently matched by a worker applying the stain manually. A process of application to ensure consistently evening applied stain with no splatter.

### CROSS-REFERENCE TO RELATED APPLICATIONS

This application claims the benefit of provisional patent application Ser. No. 60/616.108 filed 2004 Oct. 05 by the present inventor.

### FEDERALLY SPONSERED RESEARCH

Not Applicable

### SEQUENCE LISTING OR PROGRAM

Not Applicable

### BACKGROUND OF THE INVENTION

1. Field of invention

This invention relates to the wood floor industry, specifically to an improved method of stain application.

b 2. Prior art

Wood floor contractors have applied stain in the past by ragging on and ragging off Stain on their hands and knees. Using cloth rags as the media to carry the stain to the floor. The down side has always been fatigue on knees and arms along with plenty of wasted stain on the rags.

Applying by the above method of ragging on ragging off because of fatigue leads to uneven application of stain which can cause the floor to look blotchy in color.

Other methods have included pouring stain onto the floor then pushing the running buffer into the stain using a pad on the bottom of the buffer to spread the stain. The result was stain would fly out from the buffer onto the walls because of the pushing of the buffer into the puddle of stain. The contractor still had to get back down on their knees to Wipe the excess stain from the floor.

### OBJECTS AND ADVANTAGES

Accordingly, several objects and advantages of my invention are:
(a) to provide a stain applicator that utilizes the advantages of a mechanical device to assist in consistently and evenly apply stain.
(b) to provide a stain applicator that reduces the amount of stain needed to stain a floor.
(c) to provide a stain applicator that gets the worker off their hands and knees to element fatigue.
(d) to provide a stain applicator to allow the contractor a pleasant experience while allowing them a longer career in their chosen field.
   Applies stain to wood floors using a buffer. This gets the worker off his knees, which prevents fatigue and allows the worker to accomplish more work in a much shorter period of time.
   Thousands of fibers hold the stain and apply it evenly and consistently, without creating splatter.
   The buffers performance, weight and RPM, cannot be consistently matched by a worker applying the stain manually.
   Applicators are convenient and ready to use; no cutting and simple instructions. We use only 100% polyester fiber, which means there is no chance of cross-contamination from stain treatments normally found on most carpets.
   The process is to pour 6 to 12 ounces of stain in center area of applicator, fiber side up, flip applicator over onto floor, set buffer on applicator, start buffer and you are applying stain. Work stain side to side following grain of wood when possible. When applicator runs low on stain, not applying consistently, walk back into stained area and rework the stain again. You are ragging off any excess stain by doing this. Lean buffer back, flip applicator over, refill with stain and start the process over. If you stop the buffer while applying, immediately lean the buffer back and flip applicator over so not to create a circle of stain. When starting back up staining always rework the area where you stopped to remove any excess stain.

### SUMMARY

In accordance with the present invention a Buffer Brush Stain Applicator comprises a piece of carpet cut to useable size with a application process of applying.

### DRAWINGS—FIGS

Illustration 1

FIG. 1—Laser cut to insure consistent size and for the benefit of sealing the edge from ravel more so then razor cut but not limited to laser cutting only. Circle of carpet designed to fit under a floor buffer of most sizes. Nap or fiber of carpet to face floor surface.

FIG. 2—Center section of applicator is where contractor would pour stain from can or measuring cup, amount of stain applied to applicator would vary depending on thickness and density of carpet used. Applicator needs to be nap or fiber up laying on the floor flat to have stain poured into the center area then flipped over and the buffer pad set on top of the applicator, the staining can begin by starting the buffer up and working around the room applying stain onto the floor with consistent results stopping to refill with stain as needed.

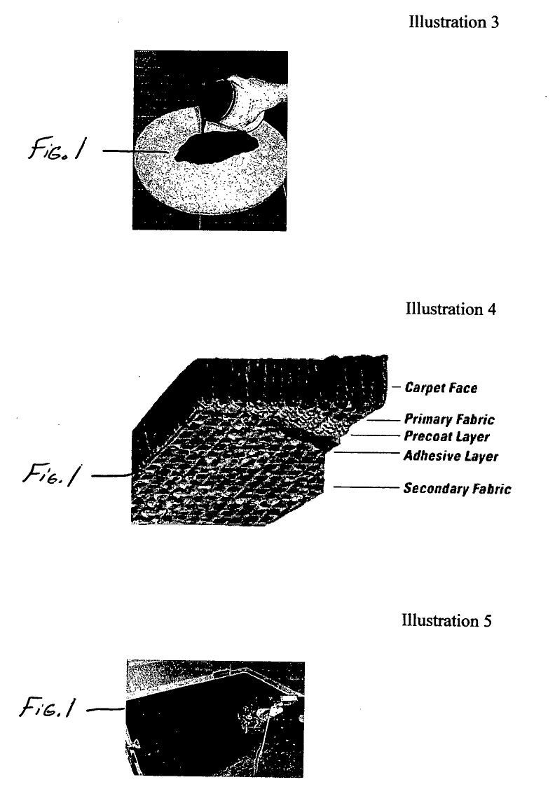

Illustration 2

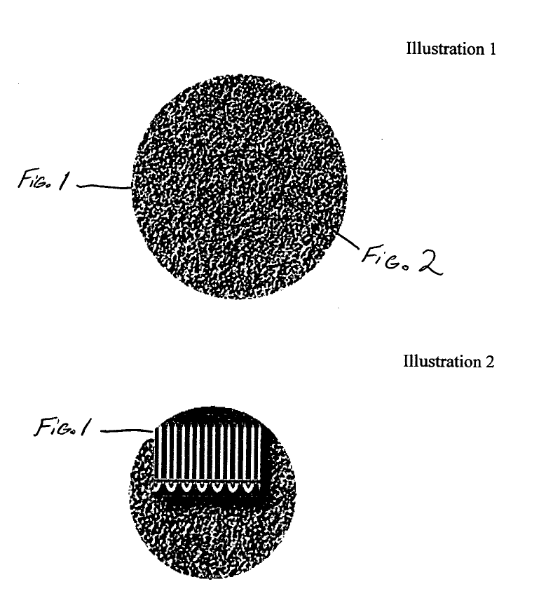

FIG. 1—Side view of carpet. Carpet can be of many different configurations of height, weight and construction. Such as fibers that are looped, sheared or even sculptured.

Illustration 3

FIG. 1—When stain is applied or poured only into the center of the applicator you are ensuring that when applying stain to the floor no splatter will occur.

Illustration 4

FIG. 1—General description of carpet construction not meant to exclude other types of construction that still apply, like Woven or Needlepunch.

Illustration 5

FIG. 1—Photo of genetic floor buffer applying stain.

### DETAILED DESCRIPTION

The following description describes what elements it takes, when combined, to create a new stain applicator that will make the tedious task of staining hardwood floors on your hands and knees obsolete.

Five years ago I entered a new field of business, “Wood Floor & Refinishing,” this has allowed me the chance to utilize carpeting as the material to contain and spread stain onto wood floors, when cut into a perfect circle, then combined with the mechanical assistance of a tool that is already a part of the wood floor contractor's equipment—a buffer.

Applying stain with a buffer, using carpet as the material to contain and spread the stain, with continuous circular motion and evenly distributed weight created by the buffer, consistently delivers evenly applied stain. This will take the on-your-knees fatigue-creating task of staining wood floors into a pleasant event that not only uses less stain, but also saves the worker time and energy.

By using a material (carpet) that is mass produced at a low cost for the flooring industry as the media to hold, carry and spread the stain, and then cutting the material to a precise consistent marketable dimension and combined it with a application process, then adding a mechanical method of motion, “buffer,” altogether make the “buffer brush” able to eliminate fatigue. This invention is worthy of a patent because it gets the worker off his knees, reduces stain consumption and saves time.

The process is to pour 6 to 12 ounces of stain in center area of applicator, less stain for darker stains (6) and more for lighter stains (12), fiber side up, flip applicator over onto floor, set buffer on applicator, start buffer and you are applying stain. Work stain side to side following grain of wood when possible. When applicator runs low on stain, not applying consistently, walk back into stained area and rework the stain again. You are ragging off any excess stain by doing this. Lean buffer back, flip applicator over, refill with stain and start the process over. If you stop the buffer while applying, immediately lean the buffer back and flip applicator over so not to create a circle of stain. When starting back up staining always rework the area where you stopped to remove any excess stain. Always keep a rag in your back pocket to blend in the corners. A 178 RPM buffer is recommended for application.

I claim:

1. A stain applicator where in applies stain to wood floors using a buffer as the means of mechanical movement.

2. The applicator of claim 1 where in said body of material is composed of carpeting.

3. The applicator of claim 1 where in said body is circular.

4. A method of the process of applying stain using said body of applicator of claim 1
(a) Said body of applicator of claim 1 on floor fiber side up.
(b) Pour stain in and around the center of said body of applicator of claim 1
(c) Flip said body of applicator of claim 1 over fiber side down onto floor.
(d) Set buffer on top of said applicator of claim 1, start buffer and you are applying stain.
Whereby said applicator saves time, energy, stain and gets the worker off their knees while thousands of fibers hold the stain and apply it evenly and consistently without creating splatter.
